(19) United States
(12) Patent Application Publication
(10) Pub. No.: US 2009/0172127 A1
(43) Pub. Date: Jul. 2, 2009

(54) SYSTEM AND METHODS FOR RECOMMENDING NETWORK CONTENT BASED UPON SOCIAL NETWORKING

(75) Inventors: Hema Srikanth, Raleigh, NC (US); Bryan Osenbach, Cary, NC (US); Jeffrey Sloyer, Fishersville, VA (US)

Correspondence Address: Novak Druce + Quigg LLP, CityPlace Tower, 525 Okeechobee Blvd., Fifteenth-Floor, WEST PALM BEACH, FL, 33401, US

(73) Assignee: INTERNATIONAL BUSINESS MACHINES CORPORATION, Armonk, NY (US)

(21) Appl. No.: 11/966,338

(22) Filed: Dec. 28, 2007

(51) Int. Cl. G06F 15/16

(52) U.S. Cl. 709/217

(57) ABSTRACT

A system, apparatus, and method for recommending network content based upon shared preferences among members of a social network is provided. The method can be a computer-implemented method that includes determining a membership of a user in at least one social network in response to the user accessing a communications network. The method can further include identifying network content associated with other members of the at least one social network. Based upon the shared preferences, a list can be generated and transmitted to the user, the list comprising at least one network site for accessing the identified network content.

### FIELD OF THE INVENTION

The present invention is related to the field of networking, and more particularly, to systems and methods for recommending network content based upon social network attributes.

### BACKGROUND OF THE INVENTION

Interactive television, the Internet, and a plethora of other communication networks provide an extensive and diverse array of sources of network content that can be readily accessed by individuals who are communicatively linked to one or more such networks. A network user, however, typically must browse through multiple sites or channels to determine the particular network content that is of interest to the user. Often times, a user is unaware of existing or scheduled network content, such as a television program, that would be of considerable interest to the user given the user's personal interests.

Even though a particular user may be a member of a social network in which members share common preferences for particular network content, there is to date no effective and efficient mechanism for identifying to the user particular network content based upon these shared preferences. Accordingly, there is a need for mechanism whereby network content can be proposed or recommended to a network user based upon shared preferences among members of the user's social network.

### SUMMARY OF THE INVENTION

The present invention is directed to a system, apparatus, and related methods for recommending network content based upon content preferences shared among the members of a social network. One object of the invention is to provide a mechanism whereby network content and network sites can be dynamically determined and proposed to user when a user accesses a network, the proposal being based upon shared preferences among members of a social network. Another object of the invention is to provide a mechanism whereby over time, members of a social network can form sub-networks based upon shared preferences, thereby allowing users to more effectively manage their time in identifying and accessing network content of particular interest.

One embodiment of the invention is a system for recommending network content provided over a communications network. The system can include a centralized social-networking and content-recommending site, at least one social networking site, and a plurality of client sites. Each client site can comprise a social network module and can be communicatively linked to each social networking site as well as to the centralized social-networking and content-recommending site. Each social network module can be configured to convey, to the centralized social-networking and content-recommending site, network content preferences of members of one or more social networks corresponding to one or more social network sites. The centralized social-networking and content-recommending site can be configured to convey to each of the client sites a list comprising at least one network site for accessing network content identified based on the network content preferences.

Another embodiment of the invention is an apparatus for recommending network content provided over a communications network. The apparatus can include a device for receiving content through a communications network and for conveying data to a network-connected site through the communications network. The apparatus further can include a social networking module executing within or otherwise communicatively linked to the device. The module can be configured to convey through the communications network content preferences of a member of at least one social network corresponding to at least one social network site. The module can be further configured to receive through the communications network a list comprising at least one network site for accessing network content identified based on network content preferences of other members of the at least one social network.

Still another embodiment of the invention is a computer-implemented method for recommending network content. The method can include determining a membership of a user in at least one social network in response to the user accessing a communications network. The method further can include identifying network content associated with other members of the at least one social network, and transmitting to the user a list comprising at least one network site for accessing the identified network content.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of an exemplary network environment in which a system for recommending network content provided over the network, according to one embodiment of the invention, is utilized.

FIG. 2 is a schematic view of certain operative features of the system illustrated in FIG. 1.

FIG. 3 is a flowchart of exemplary steps in a method for recommending network content provided over a communications network, according yet another embodiment of the invention.

### DETAILED DESCRIPTION

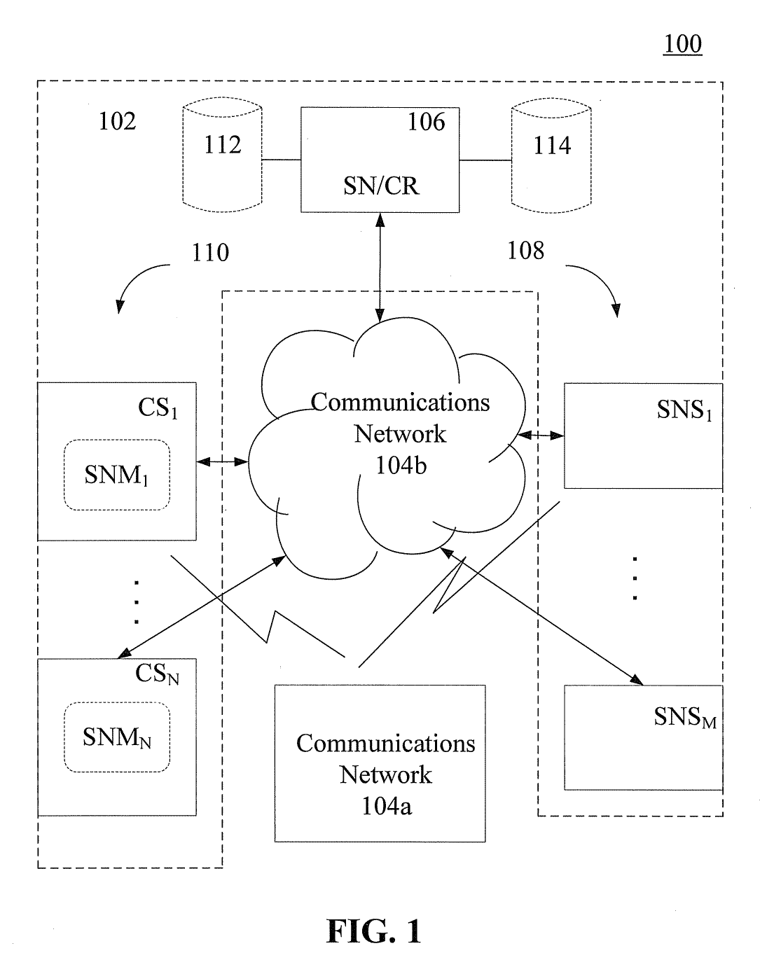

FIG. 1 is a schematic view of an exemplary communications network 100 in which a system 102 for recommending network content that is provided over a communications network, according to one embodiment of the invention, is utilized. The communications network 100 can comprise a plurality of different networks. For example, in a particular embodiment the communications network 100 can include a television network 104a for conveying television shows, news, and other network content via wireless and/or wire-line signals to various television receiving devices, as well as a data communications network 104b such as the Internet.

The system 102 illustratively includes a centralized social-networking and content-recommending (SN/CR) site 106, one or more social networking sites 108 (here shown as M distinct social networking sites(SNSs)), and N client sites (CSs) 110. Illustratively, each of the client sites 110 is linked to one or more of the social networking sites 108 as well as to the centralized social-networking and content-recommending site 106 through the data communications network 104b. Optionally, the centralized social-networking and content-recommending (SN/CR) site 106 can be communicatively linked to one or more databases 112, 114 for electronically storing social networking and/or network content data that is processed according to the procedures described herein.

Each social network site 108 can comprise a computing device such as a server. More particularly, a social network site 108 can be a social networking website, such as Facebook or My space, through which various users can interactively exchange personal profiles, blogs, groups, photos, music and/or videos. Likewise, each client site 110 can comprise a computing device, such as a personal computer (PC), for exchanging various forms of data content with other network-connected sites. Although not explicitly shown, each client site 110 can optionally include additional communications devices such as a television and/or digital video recorder such as the TiVo® (TiVo is the registered mark of TiVo, Inc. of Alviso, Calif.) with which various types of network content can be received.

As illustrated, each of the N client sites 110 further includes a social networking module SNMᵢ that is communicatively linked to one or more of the social networking sites 108 as well to the centralized social-networking and content-recommending site 106. The N social networking modules SNMᵢ, i=1, . . . , N correspond, respectively, to the N client sites 110 and are configured to perform the various functions described herein. The social networking modules SNMᵢ, i=1, . . . , N can be implemented in computer-readable code that when loaded in and executed by a computing device causes the device to perform the various functions. Alternatively, the social networking modules SNMᵢ, i=1, . . . , N can be implemented in dedicated hardwired circuitry. According to still another embodiment, the social networking modules SNMᵢ, i=1, . . . , N can be implemented in a combination of dedicated hardwired circuitry and computer-readable code that cooperatively perform the various functions described herein.

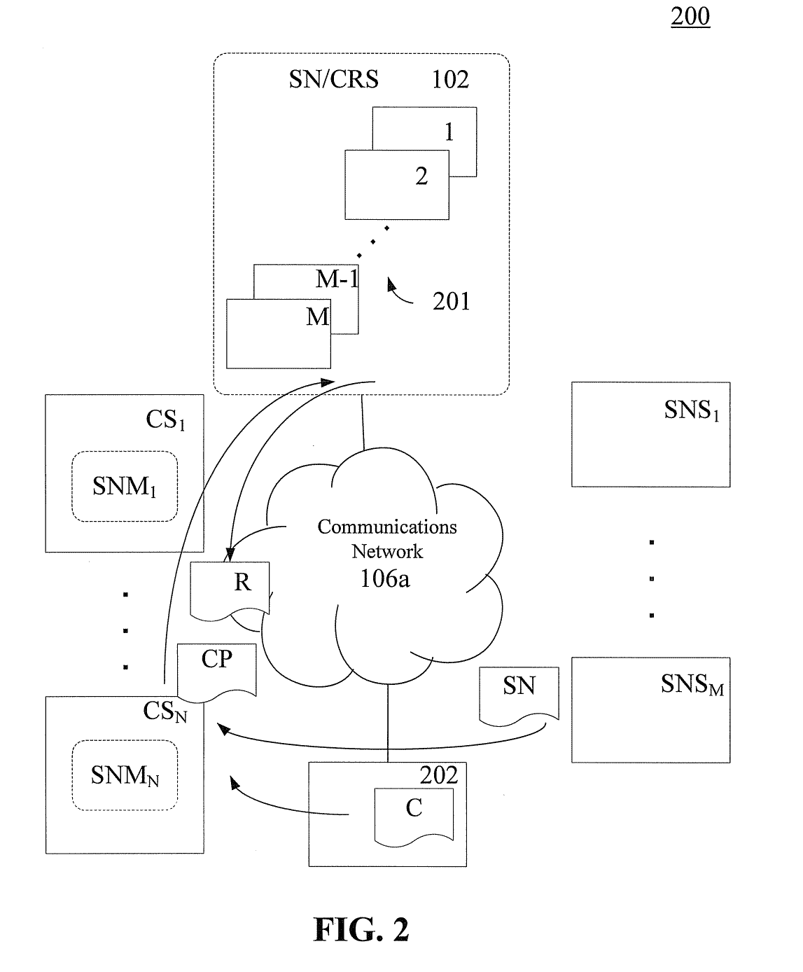

Referring additionally to FIG. 2, certain operative features of the system 102 are illustrated schematically. Each social network module SNMᵢ, i=1, . . . , N can be configured to convey, via the data communications network 104bto the centralized social-networking and content-recommending site 106, network content preferences CP of members of at least one social network corresponding to at least one of the social network sites 108. The content preferences CP can reflect or be based upon social network interactions SN conducted through one or more of the social network sites 108. Based upon the content preferences, the centralized social-networking and content-recommending site 106 can generate a list of recommended sites R and convey the list to other members of a corresponding social network, the list comprising at least one network site 202 for accessing network content C identified based on the network content preferences CP.

The network content C can be, for example, entertainment content such as a television program. Accordingly, the system 102 can provide a mechanism through which certain television programs are recommended to a user based upon common interests of other users that each belong to the same social network. The system 102 thus dynamically determines and proposes to a user a particular program carried on a certain channel based upon common interests of members of a social network where a particular member might otherwise be unaware of the program or the channel on which it is carried. Likewise, a user can collaborate within the context of his or her social network by expressing certain program preferences through the system 102.

In a particular embodiment, the client sites 110 comprise TiVo® clients with which a user can access programs remotely and set viewing preferences. For example, a first user's TiVo® client and a second user's TiVo® client can be modified by respective social networking modules SNMᵢ and social networking modules SNMⱼ to interact with different ones of the social networking sites 108. The first user connects to TiVo® from a remote client and sets certain preferences for his or her social network (e.g., login, id, and password) in the TiVo®. These preferences are set by other users and pushed to the centralized social-networking and content-recommending site 106, which allows users to set such preferences. Optionally each social networking module SNMᵢ can automatically update user preferences and push the updated preferences to the centralized social-networking and content-recommending site 106.

Additionally, or alternatively, each social networking module SNMᵢ can be configured to automatically determine network content preferences CP by determining a number of times a member of at least one social network 108 accesses a particular network site to obtain network content within a predetermined period of time. According to still another embodiment the determination can be based upon the number of members of a particular social network who access particular information content.

According to still another embodiment, the centralized social-networking and content-recommending site 106 can be configured to determine whether a network connection between a member of at least one social network 108 and at least one other member of the social network exists. If no network connection exists, the centralized social-networking and content-recommending site 106 can generate and transmit a request for permission to establish a network connection so as to facilitate an exchange of network content recommendations.

In yet another embodiment, each social network module SNMᵢ can be configured to determine a level of social connection between a member of the at least one social network and at least one other member of the at least one social network, and to enable the member to share a preference for particular network content only if the level of social connection exceeds a predetermined threshold. For example, in the context of network content comprising television programs, users can select a set of channels and/or programs that each wishes to share with members of their social networks. According to one embodiment, however, a user can opt to make content or viewer preferences private rather than public. Depending on the network connection and how socially “connected” a user is to another user requesting a connection, the former can establishes preferences for how much information is to be share through the system 102 with the requesting user. A user can make a request for information sharing contingent on whether a requesting user is identified as a member of a subset of users who are deemed closely connected.

Moreover, a user who observes that a particular program or channel is of interest to some members of a particular social network can, through the system 102, push that information 201 to the centralized social-networking and content-recommending site 106 and select other users with whom the information about the particular network content of interest is to be shared. In the event that content preferences are not already established for a particular user, the centralized social-networking and content-recommending site 106 can generate a message that is then conveyed to other users that this particular user wishes to establish a network connection and share network content preferences.

Based upon network content preferences defined by various users of the system 102, the system 102 proposes network sites where particular network content, identified based upon shared preferences of the members of the same social network, can be accessed. Each social networking module SNMᵢ can be configured to automatically initiate a recording mode at a corresponding client site 110 so as to cause information content to be recorded (e.g., using a digital video recorder that is integrated with the site). The information content that is selected for recording can be information content identified based upon the content preferences of a particular social network to which a user of the system belongs and that is being accessed at a particular time by other members of the particular social network. The user can set preferences for initiating the recording based upon content recommendations provided by the system 102. A user can narrow the scope of recommendations that will initiate the recording by providing keywords. For example, in the context of information content comprising television programs, the user can specify: “mystery shows AND shared preferences by members of sub-network A.”

The system 102 also can present a prioritized list of network content sites or channels based upon users-supplied personal attributes. These attributes can include, for example, age group, educational background, ethnicity, and personal interests. Moreover, each attributed can allocated a predetermined weight, wherein the sum of the predetermined weights equals one. The user can associate the weights to distinct attributes in a set of attributes, based upon a subjective user valuation of the different attributes

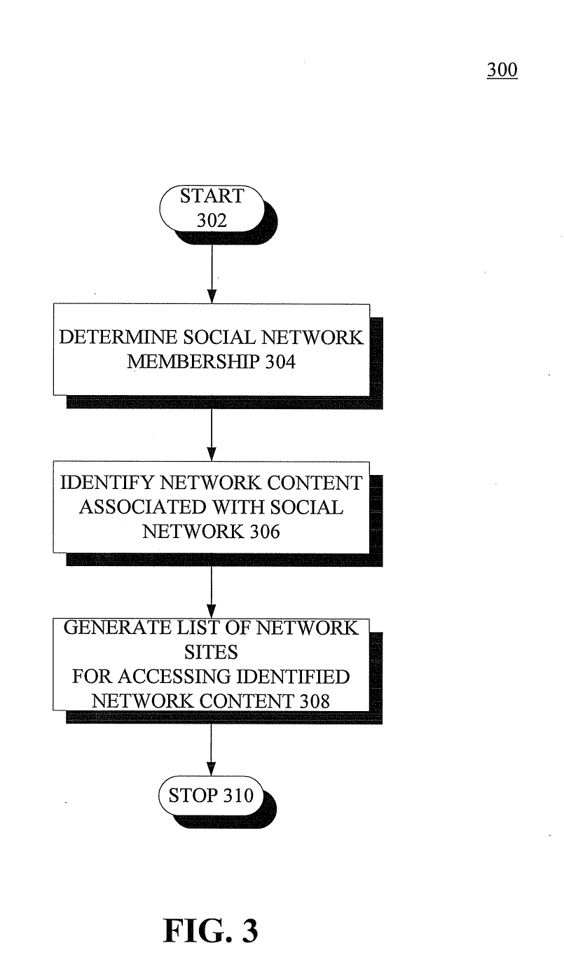

The flowchart of FIG. 3 illustrates certain method aspects of the invention. The flowchart comprises exemplary steps in a computer-implemented method 300 for recommending network content. The method 300 includes, after the start at step 302, determining a membership of a user in at least one social network in response to the user accessing a communications network at step 304. The method 300 further includes identifying network content associated with other members of the at least one social network at step 306. At step 308, according to the method 300, a list comprising at least one network site for accessing the identified network content is conveyed to the user. The method 300 illustratively concludes at step 310.

According to a particular embodiment, step 306 of the method 300 can comprise determining the number of times a member of the at least one social network accesses a particular network site for obtaining the network content within a predetermined period of time. Moreover, if the list comprising at least one network site comprises a plurality of network sites for accessing identified network content, the method 300 further can include prioritizing the list based upon a predetermined set of attributes corresponding to the user.

The method 300 can include determining whether the number of times the particular network site was accessed by a member of the at least one social network exceeds a predetermined threshold. Accordingly, if the number of times exceeds the predetermined threshold, the method 300 can further include designating the particular network site a preferred site for the particular member or members of the social network that have accessed the particular network site more than the threshold number of times. The method 300 also can include enabling a member of the at least one social network to prevent determining the number of times the member has accessed the particular network site. Additionally, or alternatively, the method can include determining the number of members belonging to a particular social network access a particular network site.

According to another embodiment, the method 300 also can include providing a centralized network site for receiving network content recommendations from each member of the at least one social network and transmitting the network content recommendations to other members of the at least one social network.

According to yet another embodiment, the method can include determining whether a network connection between the user and at least one other member of the at least one social network exists. According to this embodiment, if no network connection exists, a request for permission to establish the network connection so as to facilitate an exchange of network content recommendations can be transmitted to the user and the at least one other member.

According to still another embodiment, the method 300 can include determining a level of social connection between the user and at least one other member of the at least one social network. According to this embodiment, the user can elect to share a preference for particular network content only if the level of social connection exceeds a predetermined threshold.

According to yet another embodiment, the method 300 can include enabling the user to elect to automatically record for later access a broadcast of particular network content if the particular network content comprises preferred network content by at least one other member of the at least one social network.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for recommending network content, the method comprising:
in response to a user accessing a communications network, determining a membership of the user in at least one social network;
identifying network content associated with other members of the at least one social network; and
transmitting to the user a list comprising at least one network site for accessing the identified network content.

2. The method of claim 1, wherein identifying network content comprises determining a number of times a member of the at least one social network accesses a particular network site for obtaining the network content within a predetermined period of time.

3. The method of claim 2, further comprising determining whether the number of times the particular network site was accessed by a member of the at least one social network exceeds a predetermined threshold, and if the number of times exceeds the predetermined threshold, designating the particular network site a preferred site for the particular member or members of the social network that have accessed the particular network site more than the threshold number of times.

4. The method of claim 2, further comprising enabling a member of the at least one social network to prevent determining the number of times the member has accessed the particular network site.

5. The method of claim 1, further comprising providing a centralized network site for receiving network content recommendations from each member of the at least one social network and transmitting the network content recommendations to other members of the at least one social network.

6. The method of claim 5, further comprising determining whether a network connection between the user and at least one other member of the at least one social network exists, and if no network connection exists transmitting to the user and the at least one other member a request for permission to establish the network connection to thereby facilitate an exchange of network content recommendations.

7. The method of claim 1, further comprising determining a level of social connection between the user and at least one other member of the at least one social network, and enabling the user to share a preference for particular network content only if the level of social connection exceeds a predetermined threshold.

8. The method of claim 1, further comprising enabling the user to elect to automatically record for later access a broadcast of particular network content if the particular network content comprises preferred network content by at least one other member of the at least one social network.

9. The method of claim 1, wherein the list comprising at least one network site comprises a plurality of network sites for accessing identified network content, and further comprising prioritizing the list based upon a predetermined set of attributes corresponding to the user.

10. A system for recommending network content provided over a communications network, the system comprising:
a centralized social-networking and content-recommending site;
at least one social networking site; and
a plurality of client sites, each client site having a social network module and being communicatively linked to the at least one social networking site and to the centralized social-networking and content-recommending site;
wherein each social network module is configured to convey, to the centralized social-networking and content-recommending site, network content preferences of members of at least one social network corresponding to the at least one social network site;
wherein the centralized social-networking and content-recommending site is configured to convey to each of the client sites a list comprising at least one network site for accessing network content identified based on the network content preferences.

11. The system of claim 10, wherein each social network module is configured to automatically determine network content preferences by determining a number of times a member of the at least one social network accesses a particular network site to obtain network content within a predetermined period of time.

12. The system of claim 11, wherein the social network module is further configured to enable a member of the at least one social network to prevent determining the number of times the member has accessed the particular network site or conveying a particular content preference to the social-networking and content-recommending site.

13. The system of claim 10, wherein each social network module is configured to enable a member of the least one social network to establish a set of social network preferences and to convey the set of social network preferences to the centralized social-networking and content-recommending site.

14. The system of claim 10, wherein the centralized social-networking and content-recommending site is configured to determine whether a network connection between a member of the at least one social network and at least one other member of the at least one social network exists, and if no network connection exists transmitting a request for permission to establish a network connection to thereby facilitate an exchange of network content recommendations.

15. The system of claim 10, wherein each social network module is configured to determine a level of social connection between a member of the at least one social network and at least one other member of the at least one social network, and to enable the member to share a preference for particular network content only if the level of social connection exceeds a predetermined threshold.

16. The system of claim 10, wherein the list comprising at least one network site comprises a plurality of network sites for accessing identified network content, and wherein the centralized social-networking and content-recommending site is further configured to prioritize the list based upon a predetermined set of attributes corresponding to a member of the at least one social network.

17. An apparatus for recommending network content provided over a communications network, the apparatus comprising:
a device for receiving content through a communications network and for conveying data to a network-connected site through the communications network; and
a social network module communicatively linked to the device, the module configured to convey through the communications network content preferences of a member of at least one social network corresponding to at least one social network site, and to receive through the communications network a list comprising at least one network site for accessing network content identified based on network content preferences of other members of the at least one social network.

18. The apparatus of claim 17, wherein the social network module is configured to automatically determine network content preferences of the member of the at least one social network by determining a number of times the member accesses a particular network site to obtain network content within a predetermined period of time

19. The apparatus of claim 17, wherein the social network module is further configured to enable the member of the at least one social network to prevent determining the number of times the member has accessed the particular network site.

20. The apparatus of claim 17, wherein the social network module is configured to enable the member of the least one social network to establish a set of social network preferences and to convey the set of social network preferences to a centralized social-networking and content-recommending site.
